(19) United States
(12) Patent Application Publication
(10) Pub. No.: US 2026/0141427 A1
(43) Pub. Date: May 21, 2026

(54) Electronic Device and Method of Calculating Travel Distance Thereof

(71) Applicants: HYUNDAI MOTOR COMPANY, SEOUL (KR); KIA CORPORATION, SEOUL (KR); Industry-Academic Cooperation Foundation, Dankook University, Yongsin-si (KR)

(72) Inventors: Hye Won Kim, Hwaseong-si (KR); Dong Hyun Moon, Hwaseong-si (KR); Kyoung Joo Kim, Hwaseong-si (KR); Young Jin Park, Hwaseong-si (KR); Hee Yun Lee, Seoul (KR); Su Hyeon Kim, Seoul (KR); Dong Min Kim, Yongin-si (KR); Hyun Joong Kim, Seongnam-si (KR)

(73) Assignees: HYUNDAI MOTOR COMPANY, SEOUL (KR); KIA CORPORATION, SEOUL (KR); Industry-Academic Cooperation Foundation, Dankook University, Yongsin-si (KR)

(21) Appl. No.: 19/334,141

(22) Filed: Sep. 19, 2025

(30) Foreign Application Priority Data
Nov. 20, 2024 (KR) 10 2024 0166132

(51) Int. Cl. G06Q 30/02; B60L 55/00; B60L 58/12; G07C 5/00

(52) U.S. Cl. CPC G06Q 30/0278; B60L 55/00; B60L 58/12; G07C 5/004; B60L 2250/12; B60L 2250/16

(57) ABSTRACT

An electronic device including one or more processors and a memory configured to store one or more programs executed by the one or more processors. When discharging of a vehicle is completed using a vehicle-to-everything (V2X) method based on a request of a user, the one or more processors are configured to calculate a virtual travel distance corresponding to a discharge amount of a battery and process the calculated virtual travel distance together with the discharge amount of the battery to be displayed on a display unit.

### CROSS-REFERENCE TO RELATED APPLICATION

This application claims the benefit of and priority to Korean Patent Application No. 10-2024-0166132, filed on Nov. 20, 2024, the disclosure of which is incorporated herein by reference in its entirety.

### BACKGROUND

### 1. Technical Field

The present disclosure relates to an electronic device and a method of calculating a travel distance thereof. More particularly, the present disclosure relates to an electronic device configured to estimate a travel distance of an electric vehicle in consideration of a virtual travel distance based on a discharge amount of a battery using a vehicle-to-everything (V2X) method, and a method of calculating a travel distance thereof.

### 2. Discussion of Related Art

Generally, vehicle-to-everything (V2X) technology is a technology for improving traffic safety and efficiency through communication between vehicles and surrounding infrastructure, other vehicles, pedestrians, and the like. From the perspective of charging or discharging, the concept of V2X expands to utilize electric vehicles as energy assets rather than simply as a means of transportation. In this case, the electric vehicles interact with the power grid and various energy-related infrastructures to supply electricity or to be charged with electricity.

Technologies related to charging or discharging of V2X are divided into, for example, a vehicle-to-grid (V2G) technology, a vehicle-to-home (V2H) technology, a vehicle-to-building (V2B) technology, and a vehicle-to-load (V2L) technology.

In V2X technology, since a process in which a significant amount of power is charged to or discharged from a high voltage (HV) battery is performed, the durability and performance of the battery can be degraded.

In the used car market, a travel distance is one important factor in evaluating the value of a used vehicle. However, unlike internal combustion engine vehicles, electric vehicles use electricity as fuel, yet a travel distance of electric vehicles is calculated in the same manner as that of internal combustion engine vehicles. While, lifetime evaluation is conducted on electric vehicle-specific parts, such as batteries and motors, from the user's perspective, a current travel distance remains one of the most intuitive indicators for evaluating a vehicle. As a result, simply providing an odometric travel distance to users omits a lot of electric vehicle information that is less critical to internal combustion engine vehicles. In particular, batteries in electric vehicles are used for additional purposes such as V2X in addition to a driving purpose. However, the travel distance calculated using the conventional method is calculated after assuming that the battery is used purely for driving, and thus the travel distance is calculated without considering a load on the battery due to purposes other than driving (e.g., V2G).

Therefore, a technology for more accurately evaluating the value of an electric vehicle by calculating a travel distance of the electric vehicle in further consideration of an additional battery load other than driving is desired.

### SUMMARY

The present disclosure is directed to providing an electronic device configured to calculate a travel distance thereof in consideration of a battery load of the electric vehicle, a method of calculating a travel distance thereof, and a vehicle having the electronic device.

Objects according to the technical spirit of the present disclosure are not limited to the above-described object and other objects that are not described may be clearly understood by those having ordinary skill in the art from the following descriptions.

According to an aspect of the present disclosure, there is provided an electronic device which includes one or more processors, and a memory configured to store one or more programs executed by the one or more processors. When discharging of a vehicle is completed using a vehicle-to-everything (V2X) method based on a request of a user, the one or more processors are configured to: calculate a current virtual travel distance corresponding to a current discharge amount of a battery; and process the calculated current virtual travel distance together with the current discharge amount of the battery to be displayed on a display unit.

The display unit may display a plurality of menus related to battery discharging. When a vehicle-to-grid (V2G) method is selected from among the plurality of menus and an amount comparison is requested through an amount comparison menu, the one or more processors may be configured to calculate each of a loss amount based on the current virtual travel distance and a time of use (TOU) income amount provided to the user when discharging is performed based on the TOU. The one or more processors may be configured to process the calculated loss amount and TOU income amount to be displayed on the display unit.

When the calculated TOU income amount is greater than or equal to the loss amount, the one or more processors may be configured to process discharging performed based on the V2G method. Additionally, when the calculated TOU income amount is greater than or equal to the loss amount, the one or more processors may be configured to calculate the current virtual travel distance corresponding to the current discharge amount of the battery when the discharging is completed.

When the V2G method is selected from among the plurality of menus and the amount comparison is not requested, the one or more processors may be configured to: process discharging performed based on the V2G method; and calculate the current virtual travel distance corresponding to the current discharge amount of the battery when the discharging is completed.

The display unit may be configured to display a plurality of menus related to battery discharging. When a vehicle-to-load (V2L) method is selected from among the plurality of menus, the one or more processors may be configured to: process discharging performed based on the V2L method; and calculate the current virtual travel distance corresponding to the current discharge amount of the battery when the discharging is completed.

When the discharging is completed, the one or more processors may be configured to: calculate a cumulative virtual travel distance corresponding to a cumulative discharge amount of the battery; and process the calculated cumulative virtual travel distance together with the cumulative discharge amount of the battery to be displayed on the display unit.

The one or more processors may be configured to: add the calculated cumulative virtual travel distance to an actual travel distance provided by an odometer to estimate a total travel distance of the vehicle; and process the estimated total travel distance to be displayed on the display unit.

The one or more processors may be configured to calculate the cumulative virtual travel distance by: Cumulative virtual travel distance=Cumulative discharge amount of battery (kWh)×Average electric power efficiency of vehicle while driving (km/kWh)×a.

In the above noted equation, “a” denotes a country-specific travel distance reflection factor.

According to another aspect of the present disclosure, there is provided a method of calculating a travel distance. The method is performed by an electronic device including one or more processors and a memory configured to store one or more programs executed by the one or more processors. The method includes calculating a current virtual travel distance corresponding to a current discharge amount of a battery when discharging of the electric vehicle is completed using a V2X method based on a user request. Additionally, the method includes displaying the calculated current virtual travel distance together with the current discharge amount of the battery on a display unit.

The calculating of the current virtual travel distance may include: selecting a V2G method from among a plurality of menus related to battery discharging; and requesting an amount comparison through an amount comparison menu after the V2G method is selected. Additionally, the calculating of the current virtual travel distance may include: calculating each of a loss amount based on the current virtual travel distance and a TOU (time-based rate system) income amount provided to the user when discharging is performed based on the TOU; and displaying the calculated loss amount and the TOU income amount on the display unit.

The calculating of the current virtual travel distance may further include: processing discharging performed based on the V2G method when the calculated TOU income amount is greater than or equal to the loss amount; and calculating the current virtual travel distance corresponding to the current discharge amount of the battery when the discharging is completed.

The calculating of the current virtual travel distance may further include: processing discharging performed based on the V2G method when the V2G method is selected from among the plurality of menus and then the amount comparison is not requested; and calculating the current virtual travel distance corresponding to the current discharge amount of the battery when the discharging is completed.

In the calculating of the current virtual travel distance, when a V2L method is selected from among a plurality of menus related to battery discharging, discharging is processed based on the V2L method, and the current virtual travel distance corresponding to the current discharge amount of the battery may be calculated when the discharging is completed.

The method may further include, when the discharging is completed; calculating a cumulative virtual travel distance corresponding to a cumulative discharge amount of the battery; and displaying the calculated cumulative virtual travel distance and the cumulative discharge amount of the battery on the display unit.

The method may further include: adding the calculated cumulative virtual travel distance to an actual travel distance provided by an odometer to estimate a total travel distance of the electric vehicle; and displaying the estimated total travel distance on the display unit.

The calculating of the cumulative virtual travel distance may be performed by: Cumulative virtual travel distance=Cumulative discharge amount of battery (KWH)×Average electric power efficiency of vehicle while driving×a.

In the above noted equation, “a” denotes a country-specific travel distance reflection factor.

### BRIEF DESCRIPTION OF THE DRAWINGS

The above and other objects, features, and advantages of the present disclosure should become more apparent to those having ordinary skill in the art by describing embodiments thereof in detail with reference to the accompanying drawings, in which:

FIG. 1 is a diagram illustrating a travel distance calculation system according to one embodiment of the present disclosure;

FIG. 2 is a block diagram of an electronic device for calculating a travel distance according to one embodiment of the present disclosure;

FIG. 3 is a diagram of a menu screen displayed on a display unit;

FIG. 4 is a diagram of an amount comparison menu;

FIG. 5 is a diagram describing a discharge amount; and

FIGS. 6 and 7 are flowcharts illustrating methods of calculating a virtual travel distance that are performed by an electronic device according to one embodiment of the present disclosure.

### DETAILED DESCRIPTION

Hereinafter, example embodiments of the present disclosure are described in detail with reference to the accompanying drawings.

However, it should be understood that the technical spirit of the present disclosure is not limited to the embodiments disclosed below but may be implemented in many different forms. It should be understood that within the scope of the present disclosure, one or more elements of each of the embodiments may be selectively combined and substituted.

In addition, terms (including technical and scientific terms) used in the embodiments of the present disclosure have the same meanings as commonly understood by those having ordinary skill in the art to which the present disclosure belongs. It should be further understood that terms, such as those defined in commonly used dictionaries, should be interpreted as having meanings that are consistent with their meanings in the context of the related art.

Further, the terms used in the embodiments of the present disclosure are provided only to describe embodiments of the present disclosure and not for purposes of limitation.

In this specification, the singular forms include the plural forms unless the context clearly indicates otherwise, and the phrase “at least one (or one or more) of an element A, an element B, and an element C,” should be understood as including the meaning of at least one of all possible combinations of the element A, the element B, and the element C.

Further, in describing elements of the present disclosure, terms such as “first,” “second,” “A,” “B,” “(a),” and “(b)” may be used.

These terms are used to distinguish an element from another element, but the nature, order, or sequence of the elements is not limited by these terms.

It should be understood that when an element is referred to as being “connected” or “coupled” to another element, the element can be directly connected or coupled to another element, intervening elements may be present, or the element can be connected or coupled to another element through still another element.

When a component, device, element, or the like of the present disclosure is described as having a purpose or performing an operation, function, or the like, the component, device, element, or the like should be considered herein as being “configured to” meet that purpose or to perform that operation or function. Each of the component, device, element, and the like may separately embody or be included with a processor and a memory, such as a non-transitory computer readable media, as part of the apparatus.

Hereinafter, embodiments are described in detail with reference to the accompanying drawings, the same or corresponding components are denoted by the same reference numerals regardless of reference numbers, and thus the description thereof has been omitted.

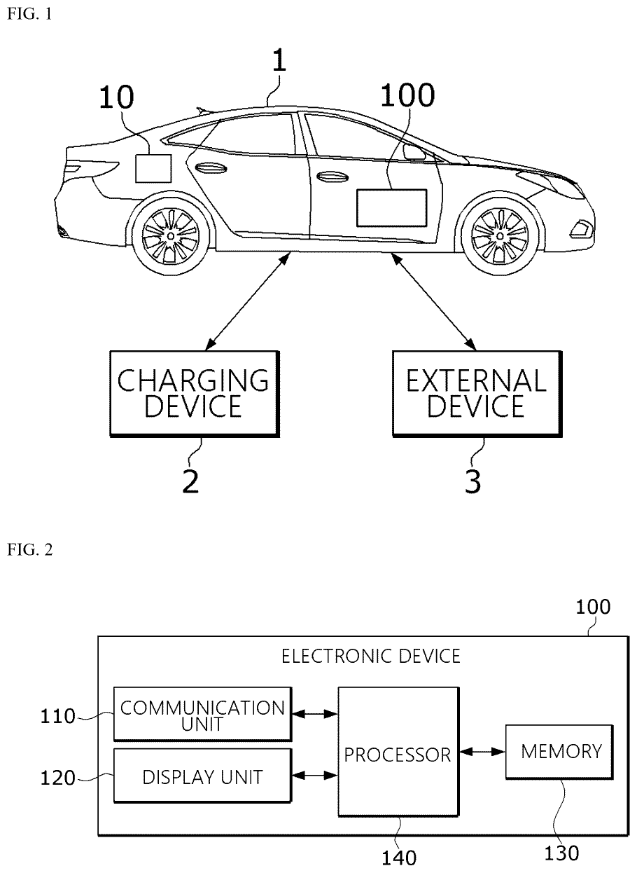

FIG. 1 is a diagram illustrating a travel distance calculation system according to one embodiment of the present disclosure.

Referring to FIG. 1, an electric vehicle 1, when driven by electric energy, may include a battery 10 charged from a charging device 2, or may include a combination of a battery 10 and a fuel cell that charges the battery. When the electric vehicle 1 is a hybrid type vehicle, the electric vehicle 1 may be provided with a combination of an internal combustion engine and an electric battery 10.

Further, the electric vehicle 1 may provide vehicle-to-everything (V2X) services, and among the V2X services, charging or discharging related services may be roughly divided into services for a vehicle-to-grid (V2G) method and services for a vehicle-to-load (V2L) method.

The V2G method is a method in which the electric vehicle 1 and a power grid interact, and power stored in a battery 10 of the electric vehicle 1 may be supplied back to the power grid through the charging device 2. In other words, the V2G method may allow the electric vehicle 1 to serve as a mobile battery that can supply power when needed, rather than simply consuming power.

By using the V2L method, electricity stored in the battery 10 of the electric vehicle 1 may be directly supplied to an external device 3 (e.g., an external electronic device or portable battery). Since the electric vehicle 1 having a V2L function can provide universal power (e.g., 220 V AC power), it is possible to connect and use the electric vehicle 1 and the external device 3.

A device for charging or discharging the electric vehicle 1 may include at least one of an on-board charger (OBC), a battery management system (BMS), a power control unit (PCU), a charge controller, an inverter, a DC-DC converter, a V2G interface for a V2G function, and a V2L interface for a V2L function.

Further, the electric vehicle 1 may include an electronic device 100 that calculates a virtual travel distance based on a discharge amount of the battery 10 and provides the calculated virtual travel distance to a user. In other words, the electronic device 100 may calculate and provide a traveling distance based on the discharge amount when the electric vehicle 1 is discharged using a V2X function. This may be useful when determining a value of the used electric vehicle 1.

Further, the electric vehicle 1 may provide a connected car service and may be driven autonomously or manually. Autonomous driving may be classified as semi-autonomous driving or fully autonomous driving. Fully autonomous driving is driving without user intervention. Semi-autonomous driving is driving by a user who intervenes depending on driving situations.

The charging device 2 may charge the battery 10 of the electric vehicle 1 or may receive power from the battery 10 and store the power in an energy storage system (ESS) or transmit the power to the power grid. For example, the charging device 2 may include at least one of a control module, which exchanges information with a BMS of the electric vehicle 1, and an off-board charger, which is included in each charging device 2 that converts an AC of the power grid into a DC to charge the battery 10 of the electric vehicle 1. Further, the charging device 2 may be a home charging device that is installed in a home.

The electronic device 100 illustrated in FIG. 1 may be implemented in a logic circuit using hardware, firmware, software, or a combination thereof, and may be implemented using a general-purpose or special-purpose computer. The electronic device 100 may be implemented using a hardwired device, a field programmable gate array (FPGA), an application specific integrated circuit (ASIC), and the like. Further, the electronic device 100 may be implemented as a system on a chip including one or more processors and controllers.

In addition, the electronic device 100 may be implemented in the form of a combination of software, hardware, or a combination thereof in a computing device or server equipped with hardware elements. The computing device or server may include various devices including all or some of a communication device such as a communication modem or the like for performing communication with various devices or wired/wireless communication networks, a memory for storing data for executing a program, a microprocessor for executing the program to perform calculations and commands, and the like.

The electronic device 100 may be mounted in an electric vehicle, implemented as a user terminal such as a smartphone or a tablet personal computer (PC), or implemented as a server such as a cloud computer.

FIG. 2 is a block diagram of an electronic device 100 for calculating a travel distance according to one embodiment of the present disclosure.

Referring to FIG. 2, the electronic device 100 for providing a travel distance according to the embodiment of the present disclosure may include a communication unit 110, a display unit 120, a memory 130, and a processor 140.

The communication unit 110 may communicate with a plurality of electronic devices mounted on the electric vehicle 1 or a user terminal. For example, the communication unit 110 may receive information on a discharge amount of the battery 10 of the electric vehicle 1 from a BMS. The communication unit 110 may manage, transmit, or receive data through a communication protocol such as a controller area network (CAN) or a local interconnect network (LIN).

Further, when the electronic device 100 does not include the display unit 120 and is mounted on the electric vehicle, the communication unit 110 may communicate with a device that acts as an intermediary with a display panel of the electric vehicle 1 to transmit a discharge-related menu or receive a user command. As intermediary devices interfacing with the display panel, components such as a vehicle control unit (VCU), an instrument cluster electronic control unit (ECU), an infotainment ECU, and the like, may be used.

In the embodiment of the present disclosure, although an example in which the electronic device 100 includes the display unit 120 is described, it should be understood that the present disclosure is not limited thereto.

The display unit 120 may display a plurality of screens generated by the processor 140. The display unit 120 may be implemented as one of various panels such as a touch panel, a hologram display, and the like.

The memory 130 may be a storage medium (non-transitory storage medium) for storing instructions executed by the processor 140 or a program including the instructions. The memory 130 may include at least one of storage media, such as a random access memory (RAM), a static RAM (SRAM), a read-only memory (ROM), a programmable ROM (PROM), an electrically erasable and programmable ROM (EEPROM), an erasable and programmable ROM (EPROM), a hard disk drive (HDD), a solid state disk (SSD), an embedded multimedia card (eMMC), a universal flash storage (UFS), and/or a web storage.

For example, the program stored in the memory 130 may include a travel distance estimation program that estimates the travel distance of the electric vehicle 1 in consideration of the discharge amount of the battery 10 and provides an estimated result to the user.

The processor 140 may control or process an operation of the electronic device 100 by executing the instructions or program stored in the memory 130. The processor 140 may include at least one of processing devices, such as an application-specific integrated circuit (ASIC), a digital signal processors (DSP), a programmable logic device (PLD), a field programmable gate array (FPGA), a central processing unit (CPU), a microcontroller, a microprocessor, and the like.

For example, the processor 140 may calculate a current virtual travel distance corresponding to a current discharge amount of the battery 10 provided in the electric vehicle 1 to execute the travel distance estimation program stored in the memory 130. The processor 140 may also estimate the travel distance of the electric vehicle 1 using the calculated current virtual travel distance. The virtual travel distance based on the discharge amount refers to a distance to which the electric vehicle 1 can be driven with power corresponding to the discharge amount.

For example, when discharging of the electric vehicle 1 is completed using a V2X method based on a user request, the processor 140 may calculate the current virtual travel distance corresponding to the current discharge amount of the battery 10, and process the calculated current virtual travel distance together with the discharge amount of the battery 10 to be displayed on the display unit 120. The current discharge amount is an actual amount of power discharged currently.

Further, the processor 140 may calculate a cumulative virtual travel distance corresponding to a cumulative discharge amount of the battery 10 of the electric vehicle 1. The cumulative discharge amount may be a total discharge amount including the current discharge amount or a total discharge amount before the current discharge after discharging is performed.

Further, the processor 140 may calculate a virtual travel distance based on an expected discharge amount, before actual discharging is performed in the electric vehicle 1, i.e., even when the electric vehicle 1 is not connected to the charging device 2 or the external device 3.

Hereinafter, in the embodiment of the present disclosure, in the cases in which the electric vehicle 1 has been discharged based on a V2X method and when it has not, operations in which a current virtual travel distance and a cumulative virtual travel distance are calculated, and a total travel distance of the electric vehicle 1 is estimated and provided using the cumulative virtual travel distance and an actual travel distance provided by an odometer is described.

For example, when the electric vehicle 1 in a chargeable/dischargeable state is connected to the charging device 2 or the external device 3 and a first state of charge (SOC) of the battery 10 is set by the user, the processor 140 may process a menu screen 300 including a plurality of menus related to battery discharging to be displayed on the display unit 120. The first SOC is a residual SOC set by the user and is a desired amount of the remaining charge after the battery 10 is discharged. The first SOC may be set and changed through the display unit 120.

The processor 140 may receive information on a current SOC and the first SOC through the BMS to calculate expected discharge amount information or may receive the expected discharge amount information based on the first SOC through the BMS. In the latter case, the BMS may know the expected discharge amount information from a difference between the current SOC and the first SOC of the battery 10.

Further, the processor 140 may receive current discharge amount information of the discharged battery 10 through the BMS when discharging is completed. The BMS may know the current discharge amount information from a difference between the current SOC, which is a remaining amount of the battery 10 immediately before discharging is performed, and the first SOC.

The processor 140 may receive a report indicating that the electric vehicle 1 is connected in a chargeable/dischargeable state through an OBC or the BMS.

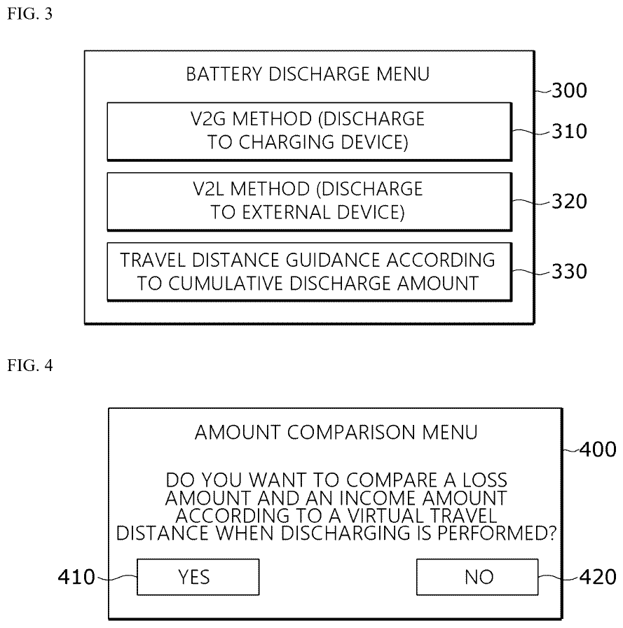

FIG. 3 is a diagram of the menu screen 300 displayed on the display unit 120.

Referring to FIG. 3, the plurality of menus displayed on the menu screen 300 may include a V2G method 310, a V2L method 320, and a travel distance guidance 330 according to a cumulative discharge amount.

When the user selects the V2G method 310, the processor 140 may generate an amount comparison menu 400 as a user option and display the generated amount comparison menu 400 on the display unit 120.

FIG. 4 is a diagram of the amount comparison menu 400.

Referring to FIG. 4, the amount comparison menu 400 may include a query such as “Do you want to compare a loss amount based on a virtual travel distance and an income amount when discharging is performed?” When the user selects “Yes” 410 in the amount comparison menu 400, i.e., when the user requests an amount comparison through the amount comparison menu 400, the processor 140 may calculate a loss amount based on an expected travel distance and a time of use (TOU) income amount that is provided to the user when discharging is performed based on the TOU (time-based rate system), and process the calculated loss amount and the TOU income amount to be displayed on the display unit 120.

When the battery 10 performs discharging to the charging device 2, the processor 140 may calculate the loss amount by converting the expected travel distance equivalent to the energy corresponding to the expected discharge amount and the used car price of the electric vehicle 1 per km based on the first SOC set by the user. For example, when the price of the used car that has traveled 10,000 km is 10 million KRW, and a price conversion rate is 1,000 KRW/km, the loss amount may be calculated by multiplying the expected travel distance by the price conversion rate.

Further, the processor 140 may use TOU information received periodically or in real time to calculate the amount of income that the user has receive when the electric vehicle 1 is discharged by the expected discharge amount. For example, a telematics control unit (TCU) of the electric vehicle 1 may receive the TOU information from a power company or a smart grid network and transmit the TOU information to a charging management system, and the charging management system may transmit the received TOU information to the electronic device 100. The charging management system may be, for example, a vehicle control unit (VCU).

When the calculated TOU income amount is greater than or equal to the loss amount, the processor 140 may process discharging to be performed automatically to the charging device 2 based on the V2G method, and when the discharging is completed, the processor 140 may calculate a current virtual travel distance corresponding to a current discharge amount of the battery 10.

The processor 140 may calculate the current virtual travel distance corresponding to the current discharge amount of the battery 10 using Equation 1.

$$Current virtual travel distance = Current discharge amount of battery ( kWh ) \times Average electric power efficiency of vehicle while driving ( km / kWh ) \times a \qquad [ Equation 1 ]$$

In Equation 1, the current discharge amount of the battery 10 is an actual discharge amount discharged from the charging device 2, and the average electric power efficiency of the vehicle while driving is an average electric power efficiency of each vehicle recorded in the electric vehicle 1. For example, a cumulative average electric power efficiency for a previous month or the like may be used.

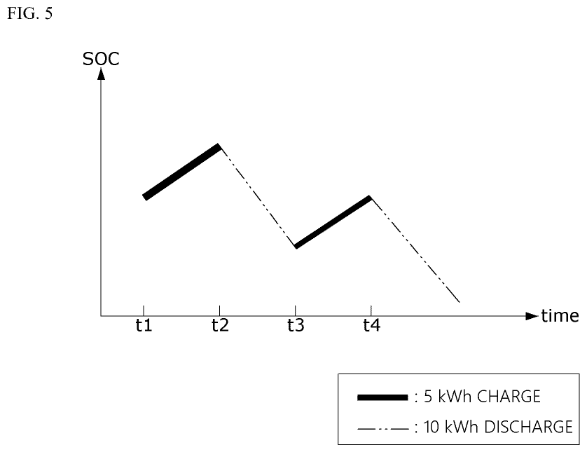

FIG. 5 is a diagram describing a discharge amount.

Referring to FIGS. 5, 5 kWh charging, 10 kWh discharging, 5 kWh charging, and 10 kWh discharging were sequentially performed on the electric vehicle 1 from a past time point t1 to a current time point t4. This may mean that a charge amount from t1 to t2 is 5 kWh, a discharge amount from t2 to t3 is 10 kWh, a charge amount from t3 to t4 is 5 kWh, and a discharge amount after t4 is 10 kWh. The charge and discharge may occur continuously without a time gap or may occur with a time difference. When calculating the current virtual travel distance, the processor 140 may calculate the current virtual travel distance using the discharge amount of 10 kWh discharged at the current time point t4.

Further, “a” denotes a country-specific travel distance reflection factor. The country-specific travel distance reflection factor is a coefficient that adjusts a travel distance calculated by an official driving cycle to the local regional characteristics in consideration of a road environment, climate conditions, driving habits, and the like of each country or region. Through the country-specific travel distance reflection factor, users may more objectively understand travel distances and fuel efficiency (or electric power consumption) of vehicles, and manufacturers may provide vehicle performance tailored to the local environment.

The country-specific travel distance reflection factor may be calculated in a manner determined for each country and stored in the memory 130 or calculated using Equation 2.

$$Country - specific travel distance reflection factor = Battery usage ( kWh ) in country - specific certified driving cycles / Discharge amount ( kWh ) in country - specific certified driving cycle \qquad [ Equation 2 ]$$

In Equation 2, a battery usage (kWh) in a country-specific certified driving cycle refers to a battery usage while driving in a certified driving cycle, which can mean (initial battery energy (kWh)-battery energy after driving (kWh)). A discharge amount (kWh) in a country-specific certified driving cycle refers to a total battery discharge amount (kWh) while driving in the certified driving cycle, and the charging amount due to regenerative braking may be excluded.

The processor 140 may process information on the current virtual travel distance and current discharge amount calculated using Equation 1 to be displayed on the display unit 120.

Further, when the current virtual travel distance is calculated after discharging is completed, the processor 140 may calculate a cumulative virtual travel distance corresponding to a cumulative discharge amount of the battery 10 and process the calculated cumulative virtual travel distance and the cumulative discharge amount of the battery 10 to be further displayed on the display unit 120.

The processor 140 may calculate the cumulative virtual travel distance using Equation 3.

$$Cumulative virtual travel distance = Cumulative discharge amount of battery ( kWh ) \times Average electric power efficiency of vehicle while driving ( km / kWh ) \times a \qquad [ Equation 3 ]$$

In Equation 3, the cumulative discharge amount of the battery 10 represents the sum of discharge amounts from a time when the electric vehicle 1 first started V2X discharging to the present. The cumulative discharge amount of the battery 10 may be the sum of all the discharge amounts discharged in a V2X method without distinguishing between V2G and V2L. Referring to FIG. 5, the cumulative discharge amount refers to a total of pure discharge amounts, 20 kWh, rather than the battery usage amount based on a total discharge amount+a total charge amount of the battery (i.e. 20 kWh−10 kWh=10 kWh). This is to consider vehicle depreciation of batteries or the like due to V2G use when V2G charge and discharge amounts are the same and a final value of a SOC is the same as an initial value thereof.

Further, a is a country-specific travel distance reflection factor, and may be stored in the memory 130 or calculated using Equation 2.

When the cumulative virtual travel distance is calculated using Equation 3, the processor 140 may add the calculated cumulative virtual travel distance to an actual travel distance provided by an odometer to estimate a total travel distance of the electric vehicle 1, and may process the estimated total travel distance to be further displayed on the display unit 120.

Therefore, the processor 140 may calculate the current virtual travel distance based on the current discharge amount, the cumulative virtual travel distance based on the cumulative discharge amount, and the total travel distance considering the cumulative virtual travel distance and display the calculated distances on the display unit 120. As a result, the processor 140 may allow the user to collectively check and compare information related to the travel distance of the electric vehicle 1.

When the TOU income amount calculated by the amount comparison request illustrated in FIG. 4 is smaller than the loss amount, the processor 140 may automatically terminate the discharge based on V2G. Alternatively, when the calculated TOU income amount is smaller than the loss amount, the processor 140 may inquire the user through the display unit 120 whether to continue discharging. Additionally, when the user's intention to continue is received, the processor 140 may instruct the BMS or VCU to start discharging to the charging device 2. When the discharging is completed, the processor 140 may calculate the current virtual travel distance corresponding to the current discharge amount of the battery 10, the cumulative virtual travel distance, and the total travel distance.

Further, when the user selects “No” 420 in the amount comparison menu 400 of FIG. 4, i.e., when the amount comparison is not requested, the processor 140 may not perform an amount comparison procedure but instead process discharging to be performed automatically with the charging device 2 based on the V2G method. Additionally, when the discharging is completed, the processor 140 may calculate the current virtual travel distance corresponding to the current discharge amount of the battery 10.

Further, when the user selects the V2L method 320 in FIG. 3, the processor 140 may process so that discharging to the external device 3 is automatically performed based on the V2L method. When the discharging is completed, the processor 140 may calculate the current virtual travel distance based on the current discharge amount discharged to the external device 3, the cumulative virtual travel distance, based on the cumulative discharge amount, and the total travel distance considering the cumulative virtual travel distance, using Equations 1 to 3, and may process results of the calculation to be displayed on the display unit 120.

Further, when the user selects the travel distance guidance 330 based on the cumulative discharge amount in FIG. 3, the processor 140 may calculate the cumulative virtual travel distance corresponding to the cumulative discharge amount of the battery 10 before performing the discharge. As depicted in FIG. 5, when the current time point is between t3 and t4, the discharge corresponding to t4 has not yet been performed, and thus the processor 140 may calculate the cumulative virtual travel distance based on the cumulative discharge amount of 10 kWh up to t3, which is the last discharge time point. The processor 140 may request and receive information on the cumulative discharge amount from the BMS. The processor 140 may process the calculated cumulative virtual travel distance together with the cumulative discharge amount of the battery 10 to be displayed on the display unit 120.

Accordingly, the user may check the total travel distance in consideration of the discharge amount of the battery when the user wants to discharge the battery or when the user wants to periodically check the battery even when he/she does not discharge the battery.

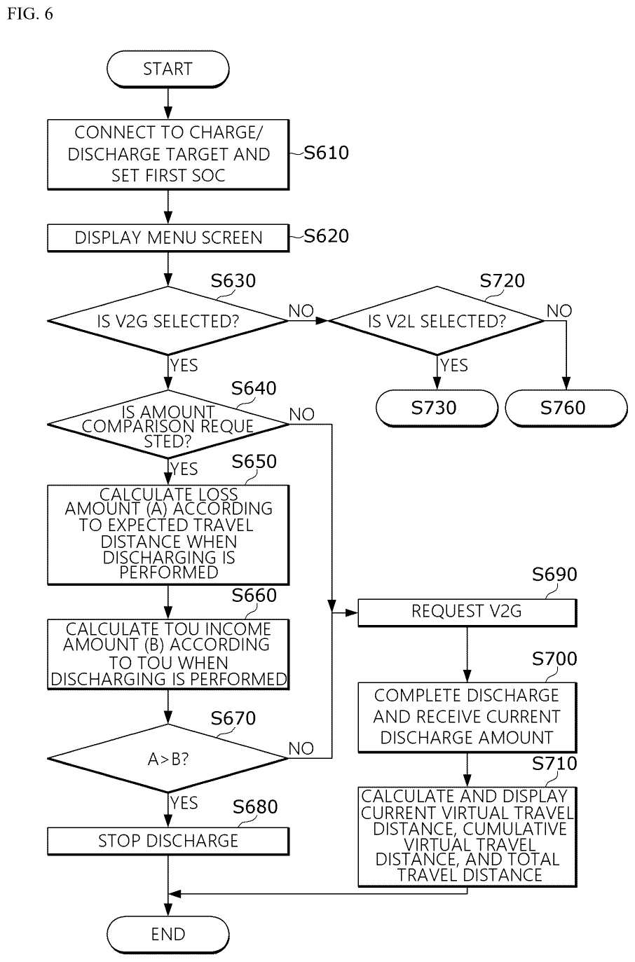

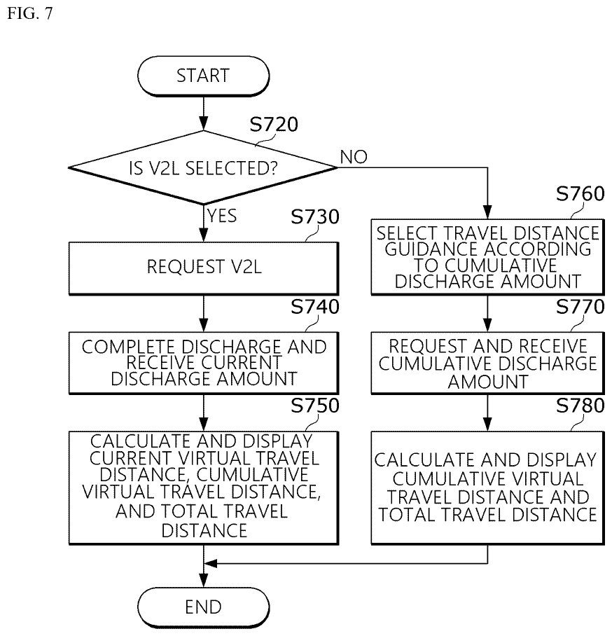

FIGS. 6 and 7 are flowcharts illustrating methods of calculating a virtual travel distance that are performed by an electronic device 100 according to one embodiment of the present disclosure.

Referring to FIG. 6, when an electric vehicle 1 in a chargeable/dischargeable state is connected to a charging device 2 or an external device 3 and a first SOC of a battery is set by a user (S610), the electronic device 100 may process a menu screen 300 including a plurality of menus related to battery discharging to be displayed on a display unit 120 (S620). The first SOC is a desired amount of the remaining charge in the battery after discharging is performed.

When the user selects a V2G method 310 in the menu screen 300 (Yes of S630), the electronic device 100 generates an amount comparison menu 400, and when the user requests an amount comparison in the amount comparison menu 400 (Yes of S640), the electronic device 100 calculates a loss amount A based on an expected travel distance when discharging is performed (S650). The expected travel distance is an expected value of a distance that a vehicle can travel with the expected discharge amount.

In addition, the electronic device 100 calculates a TOU income amount B that is provided to the user when discharging is performed based on a TOU (S660).

The electronic device 100 may process the loss amount A calculated in operation S650 and the TOU income amount B calculated in operation S660 to be displayed on the display unit 120. Additionally, when the loss amount A is greater than the TOU income amount B (Yes of S670), the electronic device 100 may process the V2G discharge to be terminated (S680).

On the other hand, when the loss amount A is less than or equal to the TOU income amount B (No of S670), the electronic device 100 requests to start discharging to the charging device 2 from the BMS based on the V2G discharge (S690).

When the V2G discharging is completed through communication between the BMS and the charging device 2, the electronic device 100 receives a current discharge amount of the battery from the BMS (S700). The current discharge amount is an amount of power actually discharged in the V2G method.

The electronic device 100 may calculate a current virtual travel distance, a cumulative virtual travel distance, and a total travel distance of the electric vehicle 1 based on the current discharge amount received in operation S700, and then process the calculated distances to be displayed on the display unit 120 (S710). In operation S710, the electronic device 100 may calculate the current virtual travel distance and the cumulative virtual travel distance using Equations 1 to 3 and add the cumulative virtual travel distance to an actual travel distance of an odometer to calculate the total travel distance.

Further, even when the user does not request an amount comparison in operation S640 (No of S640), the electronic device 100 may perform operations S690 to S710 to calculate the current virtual travel distance, the cumulative virtual travel distance, and the total travel distance and then process the calculated distances to be displayed on the display unit 120.

When the V2L method is selected in the menu screen 300 displayed in operation S620 (Yes of S720), the electronic device 100 requests to start discharging to the external device 3 from the BMS based on the V2L discharge (S730).

When the V2L discharging is completed through communication between the BMS and the external device 3, the electronic device 100 receives the current discharge amount of the battery from the BMS (S740).

The electronic device 100 may calculate the current virtual travel distance, the cumulative virtual travel distance, and the total travel distance of the electric vehicle 1 based on the current discharge amount received in operation S740, and then process the calculated distances to be displayed on the display unit 120 (S750). Since operation S750 is similar to operation S710 described above, a detailed description thereof has been omitted.

On the other hand, when a travel distance guidance based on a cumulative discharge amount is selected in the menu screen 300 displayed in operation S620 (S760), the electronic device 100 may request and receive the cumulative discharge amount, which is discharge amounts accumulated up to now, from the BMS before performing V2X discharging (S770).

The electronic device 100 may calculate the cumulative virtual travel distance corresponding to the received cumulative discharge amount using Equation 3, add the cumulative virtual travel distance to the actual travel distance and the electric vehicle 1 to estimate the total travel distance, and then process the distances to be displayed on the display unit 120 (S780).

According to the above-described embodiments of the present disclosure, the electronic device 100 may calculate a virtual travel distance based on a SOC change amount of a battery, i.e., a V2X discharge amount, based on a vehicle model, and convert the calculated virtual travel distance into a value in KRW/km units in a V2X method. In the case in which a total travel distance based on the SOC change amount is calculated and a used car price is determined based on the vehicle model, the electronic device 100 may estimate the used car price by applying the set KRW/km in consideration of the depreciation and the type of the electric vehicle 1, and then provide the estimated used car price to a user.

Accordingly, rather than simply presenting users with a current travel distance based on an odometer, a total travel distance may be presented in consideration of a virtual travel distance based on V2X. Therefore, users may check the total travel distance and vehicle condition to date more intuitively and on a similar basis to internal combustion engine vehicles.

Further, according to the embodiments of the present disclosure, by allowing users to select user options in a vehicle interface to compare a loss amount due to V2X discharging with a TOU income amount, convenience for users can be improved.

Further, those developing vehicle control logic develop a vehicle model that can calculate a travel distance based on a SOC.

As an example of use, when V2L is used at a camping site, a virtual travel distance is provided to inform a user of a battery usage.

According to the present disclosure, by calculating a travel distance in consideration of a battery load of an electric vehicle, it is possible to determine a used car price of the electric vehicle based on a battery usage. According to the present disclosure, by calculating a virtual travel distance corresponding to a battery usage and introducing the virtual travel distance into an item measuring an actual travel distance of the electric vehicle, it is possible to provide a method of calculating a travel distance familiar to the user.

Further, according to the present disclosure, it is possible to reduce the risk of original equipment manufacturer (OEM) battery certification of a vehicle using virtual travel distance information.

Further, according to the present disclosure, it is possible to share past driving and V2X usage information of an electric vehicle and improve reliability for users.

Effects obtainable in the present disclosure are not limited to the above-described effects and other effects that are not described may be clearly understood by those having ordinary skill in the art from the above detailed descriptions.

Terms described in the specification such as “unit” refer to software or a hardware component such as a FPGA or an ASIC, and the unit performs certain functions. However, the “unit” is not limited to software or hardware. The “unit” may be provided in a storage medium that may be addressed or may be executed by at least one processor. Therefore, examples of the “unit” include components such as software components, object-oriented software components, class components and task components, and processes, functions, attributes, procedures, subroutines, segments of program codes, drivers, firmware, micro codes, circuits, data, databases, data structures, tables, arrays, and variables. Components and functions provided from “units” may be combined into a smaller number of components and “units” or may be further separated into additional components and “units.” In addition, the components and the “units” may be implemented to operate one or more CPUs in a device or a secure multimedia card.

While example embodiments of the present disclosure and their advantages have been described above in detail, it should be understood by those having ordinary skill in the art that various changes, substitutions, and alterations may be made herein without departing from the scope of the disclosure as defined by the following claims.

What is claimed is:

1. An electronic device comprising:
one or more processors; and
a memory configured to store one or more programs executed by the one or more processors,
wherein, when discharging of a vehicle is completed using a vehicle-to-everything (V2X) method based on a request of a user, the one or more processors are configured to:
calculate a current virtual travel distance corresponding to a current discharge amount of a battery, and
process the calculated current virtual travel distance together with the current discharge amount of the battery to be displayed on a display unit.

2. The electronic device of claim 1, wherein the display unit displays a plurality of menus related to battery discharging, and
wherein when a vehicle-to-grid (V2G) method is selected from among the plurality of menus and an amount comparison is requested through an amount comparison menu, the one or more processors are configured to:
calculate each of a loss amount based on the current virtual travel distance and a time of use (TOU) income amount provided to the user when discharging is performed based on the TOU; and
process the calculated loss amount and TOU income amount to be displayed on the display unit.

3. The electronic device of claim 2, wherein, when the calculated TOU income amount is greater than or equal to the loss amount, the one or more processors are configured to:
process discharging performed based on the V2G method; and
calculate the current virtual travel distance corresponding to the current discharge amount of the battery when the discharging is completed.

4. The electronic device of claim 2, wherein, when the V2G method is selected from among the plurality of menus and the amount comparison is not requested, the one or more processors are configured to:
process discharging performed based on the V2G method; and
calculate the current virtual travel distance corresponding to the current discharge amount of the battery when the discharging is completed.

5. The electronic device of claim 1, wherein the display unit is configured to display a plurality of menus related to battery discharging, and
wherein when a vehicle-to-load (V2L) method is selected from among the plurality of menus, the one or more processors are configured to:
process discharging performed based on the V2L method; and
calculate the current virtual travel distance corresponding to the current discharge amount of the battery when the discharging is completed.

6. The electronic device of claim 1, wherein, when the discharging is completed, the one or more processors are configured to:
calculate a cumulative virtual travel distance corresponding to a cumulative discharge amount of the battery; and
process the calculated cumulative virtual travel distance together with the cumulative discharge amount of the battery to be displayed on the display unit.

7. The electronic device of claim 6, wherein the one or more processors are configured to:
add the calculated cumulative virtual travel distance to an actual travel distance provided by an odometer to estimate a total travel distance of the vehicle; and
process the estimated total travel distance to be displayed on the display unit.

8. The electronic device of claim 7, wherein the one or more processors are configured to calculate the cumulative virtual travel distance by:
cumulative virtual travel distance=cumulative discharge amount of battery (kWh)×Average electric power efficiency of vehicle while driving (km/kWh)×a,
wherein a is a country-specific travel distance reflection factor.

9. A method of calculating a travel distance, the method being performed by an electronic device comprising one or more processors and a memory configured to store one or more programs executed by the one or more processors, the method comprising:
calculating a current virtual travel distance corresponding to a current discharge amount of a battery when discharging of a vehicle is completed using a vehicle-to-everything (V2X) method based on a request of a user; and
displaying the calculated current virtual travel distance together with the current discharge amount of the battery on a display unit.

10. The method of claim 9, wherein the calculating of the current virtual travel distance comprises:
selecting a vehicle-to-grid (V2G) method from among a plurality of menus related to battery discharging;
requesting an amount comparison through an amount comparison menu after the V2G method is selected;
calculating each of a loss amount based on the current virtual travel distance and a time of use (TOU) income amount provided to the user when discharging is performed based on the TOU; and
displaying the calculated loss amount and the TOU income amount on the display unit.

11. The method of claim 10, wherein the calculating of the current virtual travel distance further comprises:
processing discharging performed based on the V2G method when the calculated TOU income amount is greater than or equal to the loss amount; and
calculating the current virtual travel distance corresponding to the current discharge amount of the battery when the discharging is completed.

12. The method of claim 10, wherein the calculating of the current virtual travel distance further comprises:
processing discharging performed based on the V2G method when the V2G method is selected from among the plurality of menus and then the amount comparison is not requested; and
calculating the current virtual travel distance corresponding to the current discharge amount of the battery when the discharging is completed.

13. The method of claim 9, wherein, in the calculating of the current virtual travel distance, when a vehicle-to-load (V2L) method is selected from among a plurality of menus related to battery discharging, discharging is processed based on the V2L method, and the current virtual travel distance corresponding to the current discharge amount of the battery is calculated when the discharging is completed.

14. The method of claim 9, further comprising, when the discharging is completed:
calculating a cumulative virtual travel distance corresponding to a cumulative discharge amount of the battery; and
displaying the calculated cumulative virtual travel distance and the cumulative discharge amount of the battery on the display unit.

15. The method of claim 14, further comprising:
adding the calculated cumulative virtual travel distance to an actual travel distance provided by an odometer to estimate a total travel distance of the vehicle; and
displaying the estimated total travel distance on the display unit.

16. The method of claim 15, wherein the calculating of the cumulative virtual travel distance is performed by:
cumulative virtual travel distance=cumulative discharge amount of battery (kWH)×Average electric power efficiency of vehicle while driving(km/kWh)×a,
wherein a is a country-specific travel distance reflection factor.

17. A vehicle comprising:
a battery configured to be charged from a charging device or fuel cell; and
an electronic device including one or more processors, and a memory configured to store one or more programs executed by the one or more processors,
wherein, when discharging of the vehicle is completed using a vehicle-to-everything (V2X) method based on a request of a user, the one or more processors are configured to:
calculate a current virtual travel distance corresponding to a current discharge amount of a battery, and
process the calculated current virtual travel distance together with the current discharge amount of the battery to be displayed on a display unit.

18. The vehicle claim 17, wherein the display unit displays a plurality of menus related to battery discharging, and
wherein when a vehicle-to-grid (V2G) method is selected from among the plurality of menus and an amount comparison is requested through an amount comparison menu, the one or more processors are configured to:
calculate each of a loss amount based on the current virtual travel distance and a time of use (TOU) income amount provided to the user when discharging is performed based on the TOU; and
process the calculated loss amount and TOU income amount to be displayed on the display unit.

19. The vehicle of claim 18, wherein, when the calculated TOU income amount is greater than or equal to the loss amount, the one or more processors are configured to:
process discharging performed based on the V2G method; and
calculate the current virtual travel distance corresponding to the current discharge amount of the battery when the discharging is completed.

20. The vehicle of claim 18, wherein, when the V2G method is selected from among the plurality of menus and the amount comparison is not requested, the one or more processors are configured to:
process discharging performed based on the V2G method; and
calculate the current virtual travel distance corresponding to the current discharge amount of the battery when the discharging is completed.
